(19) United States
(12) Patent Application Publication
(10) Pub. No.: US 2012/0155099 A1
(43) Pub. Date: Jun. 21, 2012

(54) Trucker Proximate Safety Flashers

(76) Inventor: James Matthew Gary Jr., Hazel Crest, IL (US)

(21) Appl. No.: 13/179,180

(22) Filed: Nov. 17, 2011

Related U.S. Application Data
(60) Provisional application No. 61/400,355, filed on Jul. 27, 2010.

(51) Int. Cl. B60Q 1/52

(52) U.S. Cl. 362/485

(57) ABSTRACT

This invention is an apparatus designated primarily for commercial trucks and trailers. It was inspired by witnessing truckers being nearly struck by vehicles in traffic. Statistical data, regarding injuries/fatalities, supports the necessity of such a device. The assembly is comprised of several components, housed inside an aluminum u-channel. The specific length of the assembly shall be determined by the height of the vehicle or trailer it will be attached. The flasher system is operated basically by pulling the assembly with enough force to release the magnetic hold from the vehicle. Immediately, the flashers are energized as the switch, which is mounted in the rear of the device closes upon separation. A gas spring provides further momentum to pivot the flasher assembly further to its predetermined stop position. To de-energize the flasher assembly, simply push the device back into position until it is held by the magnetism.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

The invention described herein is a safety lighting apparatus currently designed to be attached to larger commercial vehicles. This design is comprised of a length of l.e.d.'s (light emitting diodes), switch and flasher, which are housed inside of a reflective aluminum U-channel of approximately the same length as the l.e.d. assembly. The I.e.d. assembly is secured to the inside of the U-channel by screws and locknuts.

All components are connected in a series/parallel configuration, consisting of I.e.d.'s, one normally closed switch, and one flasher circuit. As the l.e.d. assembly is seated inside the reflective aluminum U-channel the wiring is routed along the inside of the length of the channel exiting at the top of the lighting assembly. The l.e.d. lighting assembly is attached at the top with a hinged bracket, thus allowing pivoting.

The apparatus is powered from the vehicle's existing energy source, and is energized automatically, when manually released from it's magnetic hold onto the vehicle. The lighting assembly is supported while in the operating “on” state by one gas spring. The lighting assembly is returned to the non-operating “off” state by pushing it back to the vehicle.

### BACKGROUND OF THE INVENTION

This invention, The Trucker Proximate Safety Flashers, is designed to provide an increased safety environment for operators of commercial vehicles, when outside of the vehicle. This safety lighting apparatus will pertain primarily, but not limited to the trucking industry. This invention may be included in U.S. Patent Classification 116, subclasses 28R, and 35R subclass 51, and class 340 subclasses 425.5, 463, and 468.

The invention, The Trucker Proximate Safety Flashers system offers a much higher degree of visibility, in distance and angle of approach. When compared to the orange cones, reflectors and flares, the proximate safety flashers enhances the vehicle operators' ability to be seen by oncoming traffic.

### SUMMARY

The Trucker Proximate Safety Flasher, was created with the expectancy to aid safety in times of emergency, general delivery stops, and roadside assisting for commercial vehicle operators. According to the National Transportation Safety Board's SIR 01/01 1999 summary report over 6 million crashes occurred on U.S. highways. Rear end collisions accounted for approximately one third of the crashes mentioned, of which 11.8 percent were fatal. Further, commercial vehicles were involved in 40 percent of the fatal crashes.

The Trucker Proximate Safety Flasher is designed with the advantages of highest visibility, and readily accessible, for operational mode. This invention is believed to potentially exceed the capabilities of the devices that are currently in use. This invention may also be viewed from the perspective of loss prevention, as the cones and reflectors are often left along the roadside, and flares are susceptible to moisture.

### BRIEF DESCRIPTION OF THE SEVERAL VIEWS OF THE DRAWING

FIG. 1 illustrates how the invention would be seen as viewed from the rear of a particular style of tractor/trailer truck.

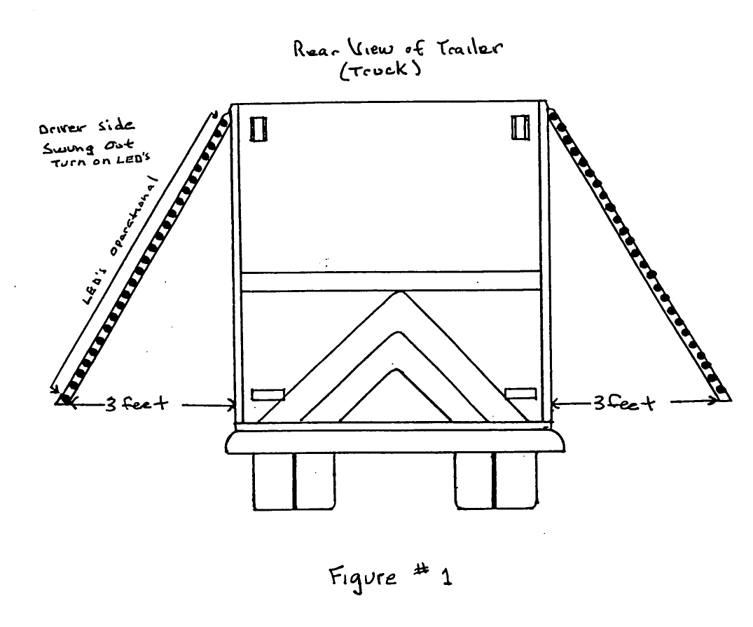

FIG. 2 illustrates mounting location of the invention as viewed from the side of a particular style of trailer.

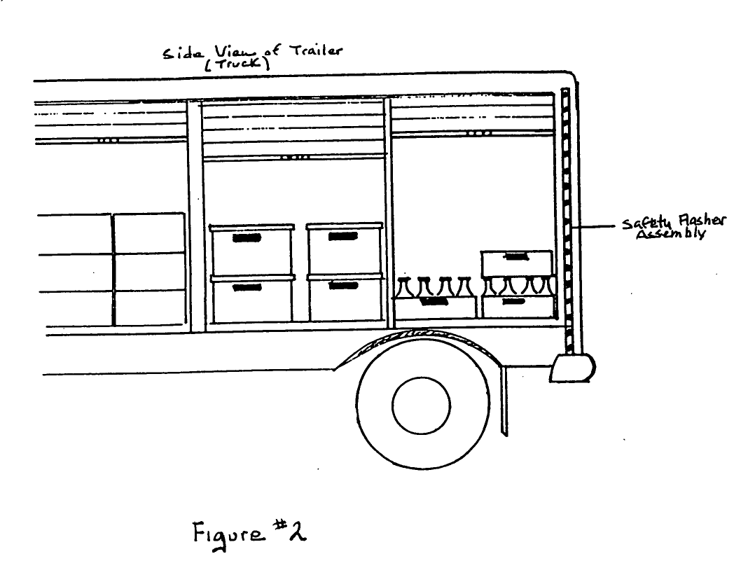

FIG. 3 depicts the components involved in the assembly of the invention.

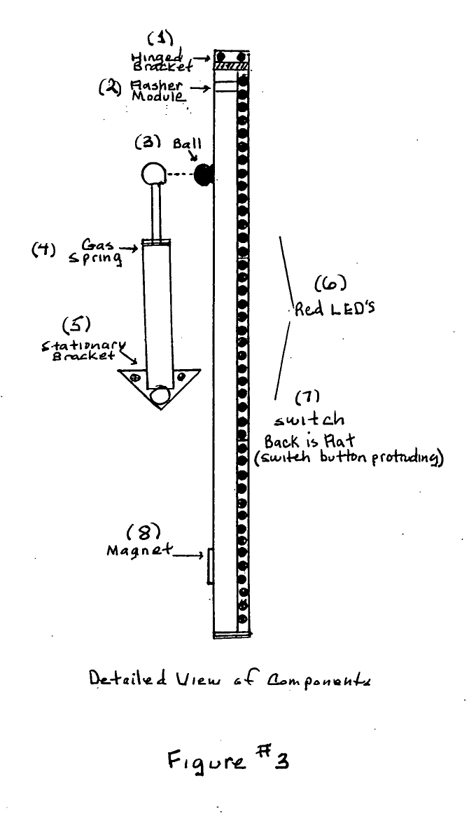

### DETAILED DESCRIPTION OF THE INVENTION

The invention titled Trucker Proximate Safety Flasher is a lighting assembly, designed to be attached vertically to a commercial vehicle. The assembly is comprised of very bright l.e.d.'s (light emitting diodes) (6) connected in a parallel configuration. The number of l.e.d.'s is predetermined by the length of the completed assembly. The remaining electronic components are connected in series with the l.e.d.'s, consisting of a flasher module (2), and a normally closed switch (7).

The wires connecting the components are routed along the inside of the 0.75 inch by 0.75 inch length of aluminum U-channel, which accommodates all parts. The lighting assembly is attached to the vehicle by a hinge (1) at the top, operation assistance and stability are provided by a gas spring (4) rated at 20 pounds of force. The unit is held in (off) position by a magnet (8) attached to the length of the aluminum U-channel, drawn to the body of the vehicle.

The length of the finished assembly is determined by the height of the vehicle for which it will be designed. Wiring exits at the top pivot point of the assembly and are spliced into the vehicle's existing electrical system. To activate the lighting system the operator pulls the assembly, breaking the magnetic hold from the truck body.

As the lighting assembly is separated from the body of the vehicle, the normally closed switch (7) completes the circuit (on) to the active components, thus energizing flashing circuitry.

Further motion via force applied from the gas spring (4), extending the assembly to it's preset limit. To deactivate the unit, the assembly is simply pushed back towards the vehicle, where the magnet holds, the switch is open and the lighting system is deactivated.

1. I, James M. Gary Jr., a U.S. citizen, claim to be the sole creator for the invention I named Trucker Proximate Safety Flashers. I alone am the designer, and creator of this invention, in which I named and presented disclosure, as described in this specification. I submit that no other person, or party was involved with the creation of this invention whether tangibly or intangible. This claim has no reference to any previous claim or claims.
